(19) United States
(12) Patent Application Publication
(10) Pub. No.: US 2013/0300993 A1
(43) Pub. Date: Nov. 14, 2013

(54) LIQUID CRYSTAL DEVICE AND ELECTRONIC APPARATUS

(71) Applicant: SEIKO EPSON CORPORATION, Tokyo (JP)

(72) Inventor: Takafumi Egami, Chitose-shi (JP)

(73) Assignee: Seiko Epson Corporation, Tokyo (JP)

(21) Appl. No.: 13/887,540

(22) Filed: May 6, 2013

(30) Foreign Application Priority Data
May 9, 2012 (JP) 2012-107358

(51) Int. Cl. G02F 1/1343; G02F 1/1337; G02F 1/1333

(52) U.S. Cl. CPC G02F 1/134336; G02F 1/133345; G02F 1/1337
USPC 349/123; 349/143; 349/138

(57) ABSTRACT

There is provided a liquid crystal device including a first substrate, a second substrate, a liquid crystal layer that is interposed between and supported by the first substrate and the second substrate, a protrusion portion that is provided on the first substrate and protrudes toward the liquid crystal layer, and a plurality of pixel electrodes that are arranged in the vicinity of the protrusion portion. In the liquid crystal device, a spacing between ends of the plurality of pixel electrodes and an end of the protrusion portion is greater than a height of the protrusion portion.

### BACKGROUND

1. Technical Field

The present invention relates to a liquid crystal device and an electronic apparatus.

2. Related Art

Generally, a liquid crystal device has a construction in which liquid crystal is injected and enclosed between a pair of substrates on which orientation processing is performed. It is known that in this process of manufacturing the liquid crystal device, when ionic impurities, for example, are mixed in at the time of liquid crystal injection, or flows out of a sealant surrounding a liquid crystal layer, the ionic impurities are diffused into and coagulated (unevenly-distributed) into a display region, thereby causing deterioration in display characteristics.

For example, JP-A-2008-58497 discloses the liquid crystal display device in which in order to suppress the deterioration in display characteristics resulting from the ionic impurities, in the pair of substrates, one substrate includes a pixel electrode formed in a pixel region and a peripheral electrode formed in a peripheral region of the pixel region and the other substrate includes a pixel electrode portion formed in the pixel region and the peripheral electrode formed in the peripheral region, and at least the one peripheral electrode is configured from the adjacent multiple electrodes, and voltage values of drive voltages being applied between the electrodes adjacent to the peripheral electrode are different.

According to the liquid crystal display device disclosed in JP-A-2008-58497, an electric field in the transverse direction occurs between the electrodes by changing electric potential between the electrodes adjacent to the peripheral electrode, and thus, in addition to the flow of the liquid crystal due to fine fluctuations, the ionic impurities within the pixel region can be moved out of the pixel region, and a display defect, such as ghosting, resulting from the ionic impurities, can be prevented.

Furthermore, JP-A-2010-113148 discloses the liquid crystal display device in which in order for an image to be displayed on a display portion that is made from multiple display pixels arranged in the shape of a matrix, a size of a minimum voltage applied to the liquid crystal layer is 1.2 V or more.

According to the liquid crystal display device disclosed in JP-A-2010-113148, by regulating the minimum voltage described above, the ghosting can be prevented from occurring in the vicinity of the boundary between a part where flow of the ionic impurities is present and a part where the flow of the ionic impurities is not present. In other words, the retention of the ionic impurities in the liquid crystal can be prevented.

The liquid crystal display device disclosed in JP-A-2008-58497 and JP-A-2010-113148 requires electronic parts such as a dedicated drive IC that is according to electro-optical characteristics of the liquid crystal being used. Furthermore, adjustment of a drive voltage (a drive waveform) is necessary, and there is a problem, such as a concern that this invites an increase in production cost and a decrease in the productivity.

### SUMMARY

The invention can be realized in the following forms or application examples.

### Application Example 1

According to Application Example 1, there is provided a liquid crystal device including a first substrate, a second substrate, a liquid crystal layer that is interposed between and supported by the first substrate and the second substrate, a protrusion portion that is provided on the first substrate and protrudes toward the liquid crystal layer, and a plurality of pixel electrodes that are arranged in the vicinity of the protrusion portion. In the liquid crystal device, a spacing between ends of the plurality of pixel electrodes and an end of the protrusion portion is greater than a height of the protrusion portion.

According to this configuration, even though ionic impurities are included in the liquid crystal layer, flow of a liquid crystal molecule due to drive of the liquid crystal layer is impeded by the protrusion portion provided between the pixel electrodes. In other words, diffusion and coagulation (uneven distribution) of the ionic impurities due to the flow of the liquid crystal molecule can be decreased. Furthermore, because a spacing between an end of the pixel electrode and an end of the protrusion portion is more greatly increased than a height of the protrusion portion, propagation of orientation disorder of the liquid crystal molecule, easily occurring in the vicinity of the protrusion portion, to a region where the pixel electrode is formed can be suppressed. That is, a decrease in display quality resulting from the ionic impurities can be suppressed and thus the liquid crystal device with a highly reliable quality can be provided.

### Application Example 2

According to Application Example 2, there is provided a liquid crystal device including a first substrate, a second substrate, a liquid crystal layer that is interposed between and supported by the first substrate and the second substrate, a plurality of pixel electrodes that are provided on the first substrate, a common electrode that is provided on the second substrate, and is arranged opposite to the plurality of pixel electrodes, interposing the liquid crystal layer, and a protrusion portion that is provided on an opening portion of the common electrode, and protrudes toward the liquid crystal layer. In the liquid crystal device, a spacing between an end of the opening portion of the common electrode and an end of the protrusion portion is greater than a height of the protrusion portion.

According to this configuration, even though ionic impurities are included in the liquid crystal layer, the flow of the liquid crystal molecule due to the drive of the liquid crystal layer is impeded by the protrusion portion provided on the opening portion of the common electrode. In other words, the diffusion and the coagulation (the uneven distribution) of the ionic impurities due to the flow of the liquid crystal molecule can be decreased. Furthermore, because a spacing between an end of the opening portion of the common electrode and an end of the protrusion portion is more greatly increased than a height of the protrusion portion, the propagation of orientation disorder of the liquid crystal molecule, easily occurring in the vicinity of the protrusion portion, to a region where the common electrode is formed can be suppressed. That is, a decrease in display quality resulting from the ionic impurities can be suppressed, and thus the liquid crystal device with a high reliability quality can be provided.

### Application Example 3

In the liquid crystal device according to Application Example 1 or 2, the height of the protrusion portion may be higher than the pixel electrode or the common electrode, and additionally is 1 μm or less.

According to this configuration, while the protrusion portion impedes the flow of the liquid crystal molecule, an occurrence of the orientation disorder of the liquid crystal molecule resulting from the protrusion portion can be suppressed.

### Application Example 4

The liquid crystal device according to Application Example 1 or 3 may further include an inter-layer insulating film that is provided between the first substrate and the plurality of pixel electrodes. In the liquid crystal device, the protrusion portion may be formed on the inter-layer insulating film.

### Application Example 5

The liquid crystal device according to Application Example 2 or 3 may include an inter-layer insulating film that is provided between the second substrate and the common electrode. In the liquid crystal device, the protrusion portion may be formed on the inter-layer insulating film.

According to this configuration, the protrusion portion can be formed using a process of forming the inter-layer insulating film.

### Application Example 6

In the liquid crystal device according to Application Example 4 or 5, the inter-layer insulating film may include at least two insulating films that are different in material, and among the at least two insulating films, the insulating film positioned on the side of the liquid crystal layer may have higher moisture absorption performance than the other insulating film.

According to this configuration, a decrease in display quality resulting from influence by water can be suppressed, and thus the liquid crystal device with a higher reliability quality can be provided.

### Application Example 7

In the liquid crystal device according to any one of Application Examples 1 to 6, the plurality of pixel electrodes may be arranged along a first direction and a second direction that intersects the first direction, in the first substrate, and the protrusion portion may include a part that extends in the first direction, and a part that extends in the second direction.

According to this configuration, by impeding the flow of the liquid crystal molecule in a direction that intersects the first direction and the second direction, as well as in the first direction and the second direction, the decrease in the display quality due to the diffusion and the coagulation (the uneven distribution) of the ionic impurities can be effectively suppressed.

### Application Example 8

In the liquid crystal device according to any one of Application Examples 1 to 7, each of the pair of substrates may include an inorganic orientation film that is formed on a surface thereof, which faces the liquid crystal layer, using an oblique deposition.

According to this configuration, because the spacing that is greater than the height of the protrusion portion is provided between the end of the protrusion portion and the end of the pixel electrode or the end of the opening portion of the common electrode, even though the film formation irregularity in the inorganic orientation film resulting from the protrusion portion occurs, the propagation of the orientation disorder of the liquid crystal molecule due to the film formation irregularity, to the pixel electrode and the common electrode can be decreased.

### Application Example 9

In the liquid crystal device according to Application Example 8, the protrusion portion may be arranged in such a manner that at least one side portion of the protrusion portion intersects a deposition direction of the oblique deposition.

According to this configuration, the flow of the liquid crystal molecule along the deposition direction of the oblique deposition can be effectively impeded by the protrusion portion.

### Application Example 10

In the liquid crystal device according to any one of Application Examples 1 to 9, the spacing between the protrusion portion and the ends of the plurality of pixel electrodes and the protrusion portion, or the spacing between the end of the opening portion of the common electrode and the end of the protrusion portion may be within a light blocking region when viewed from above.

According to this configuration, even though the decrease in the display quality resulting from the orientation disorder of the liquid crystal molecule in the vicinity of the protrusion portion occurs, it is possible to make it difficult for this to be noticeable.

### Application Example 11

An electronic apparatus according to Application Example 11 includes the liquid crystal device according to any one of Application Examples 1 to 10.

According to this configuration, the electronic apparatus can be provided that has a high display quality and reliability.

### BRIEF DESCRIPTION OF THE DRAWINGS

The invention will be described with reference to the accompanying drawings, wherein like numbers reference like elements.

FIG. 1A is a schematic plan view illustrating a configuration of a liquid crystal device, and FIG. 1B is a schematic cross-sectional view that is taken along a line IB-IB across the liquid crystal device in FIG. 1A.

FIG. 2 is a diagram of an equivalent circuit illustrating an electrical configuration of the liquid crystal device.

FIG. 3 is a schematic plan view illustrating an arrangement of pixels in the liquid crystal device.

FIG. 4A is a schematic cross-sectional view illustrating a formed state of an inorganic orientation film and an oriented state of a liquid crystal molecule in the liquid crystal device, and FIG. 4B is a schematic diagram illustrating a behavior of the liquid crystal molecule.

FIG. 5 is a schematic plan view illustrating one example of a display irregularity entailed by uneven distribution of ionic impurities.

FIG. 6A is a schematic plan view illustrating a configuration of a protrusion portion, and FIG. 6B is a schematic cross-sectional view, illustrating the configuration of the protrusion portion, which is taken along a line VIB-VIB across the protrusion portion in FIG. 6A.

FIGS. 7A to 7D are schematic cross-sectional views, each illustrating a method of forming the protrusion portion.

FIGS. 8A to 8D are schematic cross-sectional views, each illustrating another method of forming the protrusion portion.

FIG. 9 is a schematic cross-sectional view illustrating the formed state of an orientation film in the vicinity of the protrusion portion.

FIGS. 10A to 10C are schematic cross-sectional views, each illustrating another configuration example of the protrusion portion.

FIG. 11A is a schematic plan view illustrating a configuration of the protrusion portion in the liquid crystal device according to a second embodiment, and FIG. 11B is a schematic cross-sectional view illustrating a construction of the protrusion portion that is taken along a line XIB-XIB in FIG. 11A.

FIG. 12 is a schematic diagram illustrating a configuration of a projection type display apparatus as an electronic apparatus.

FIGS. 13A and 13B are schematic plan views, each illustrating an arrangement of the protrusion portion according to a modification example.

### DESCRIPTION OF EXEMPLARY EMBODIMENTS

Embodiments specified according to the invention are described below referring to the drawings. In addition, the drawings referred to are created in an enlarged or reduced way, so that a part being described is in a recognizable state.

In addition, according to the embodiments described below, for example, a case where the description “on the substrate” is provided is defined to mean that a given component is arranged on the substrate in such a manner as to come into contact with the substrate, or that the given component is arranged on the substrate with another component in between, or that one part of the given component is arranged on the substrate in such a manner as to come into contact with the substrate, or that one part of the given component is arranged on the substrate with another component in between.

### First Embodiment

According to a first embodiment, an active matrix type liquid crystal device, equipped with a thin film transistor (TFT) as a switching element of a pixel, is described as an example. The liquid crystal device also can be suitably used, for example, as a light modulation element (a liquid crystal light valve) of a projection type display apparatus (a liquid crystal projector) described below.

### Liquid Crystal Device

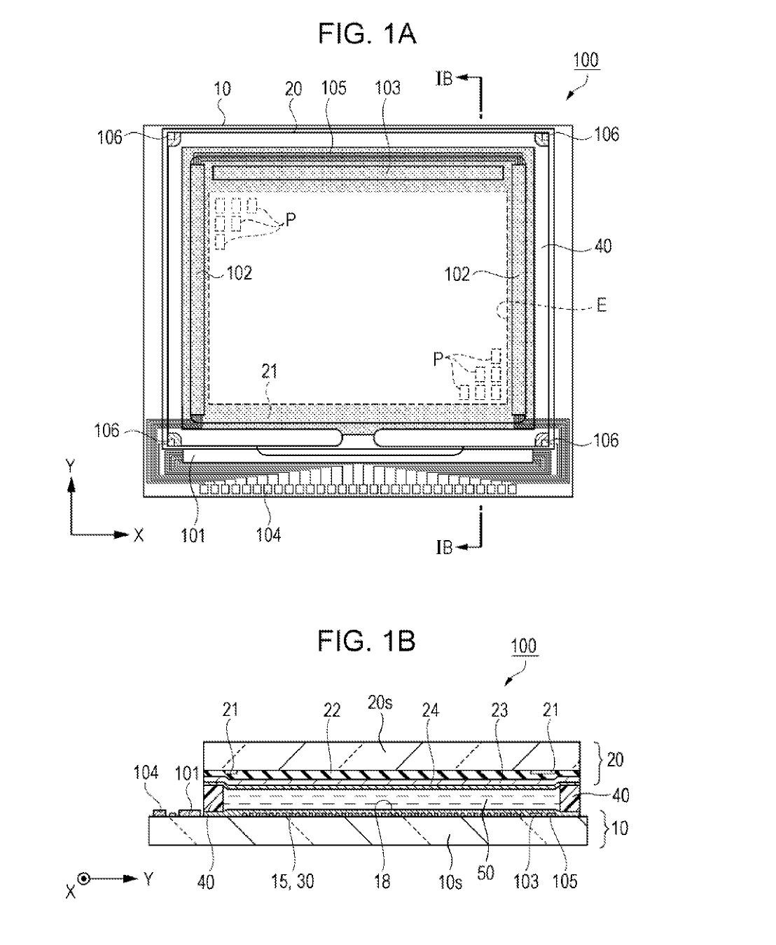

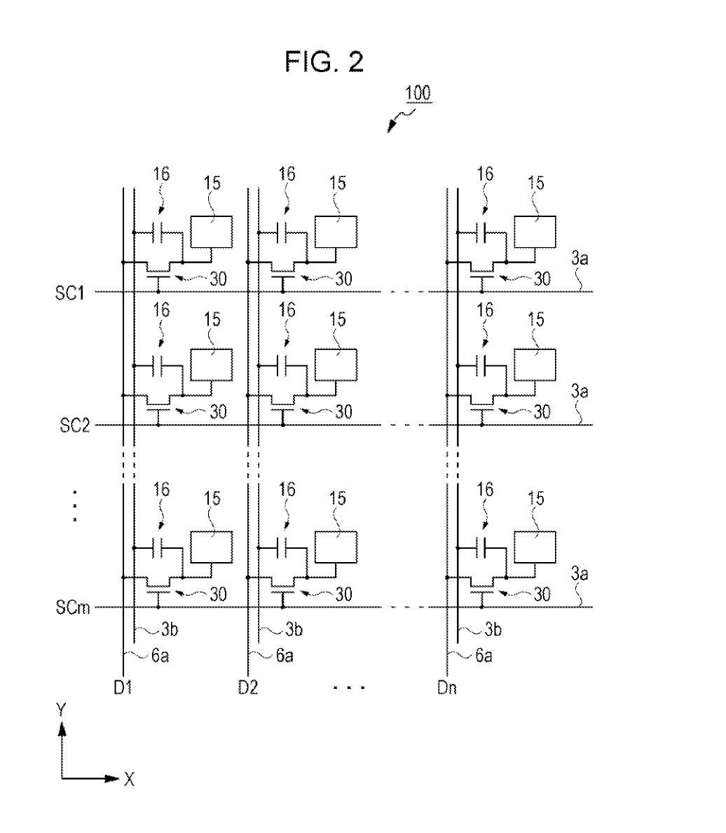

First, the liquid crystal device according to the first embodiment is described referring to FIGS. 1A and 1B and 2. FIG. 1A is a schematic plan view illustrating a configuration of the liquid crystal device, and FIG. 1B is a schematic cross-sectional view that is taken along a line IB-IB across the liquid crystal device in FIG. 1A. FIG. 2 is a diagram of an equivalent circuit illustrating an electrical configuration of the liquid crystal device.

A liquid crystal device 100 according to the first embodiment, as illustrated in FIGS. 1A and 1B, has an element substrate 10 and an opposite substrate 20 that are arranged opposite to each other, and a liquid crystal layer 50 interposed between and supported by the pair of substrates. Transparent substrates, for example, a quartz substrate and a glass substrate are used as a base substrate 10s for the element substrate 10 and a base substrate 20s for the opposite substrate 20.

The element substrate 10 is larger than the opposite substrate 20. Both substrates are attached through a sealant 40 arranged along an edge of the opposite substrate 20. Liquid crystal, which is positive or negative in dielectric anisotropy, is enclosed into a spacing between both of the substrates, thereby forming a liquid crystal layer 50. For example, an adhesive agent, such as a heat-cured or ultraviolet-cured epoxy resin is adopted, as the sealant 40. A spacer (an illustration thereof is omitted) for uniformly maintaining the spacing between the pair of the substrates is mixed into the sealant 40.

A pixel region E, in which multiple pixels P are arranged, is provided inside the sealant 40. Furthermore, a parting unit 21 is provided between the sealant 40 and the pixel region E, surrounding the pixel region E. The parting unit 21 is made from, for example, a light blocking metal or a metallic oxide. Moreover, in addition to the multiple pixels P contributing to a display, the pixel region E may include dummy pixels that is arranged in such a manner as to surround the multiple pixels P. Furthermore, a light blocking portion (a black matrix: BM), although an illustration thereof is omitted in FIGS. 1A and 1B, which partitions the multiple pixels P in the pixel region E, when viewed from above, is provided on the opposite substrate 20.

A data line drive circuit 101 is provided between a first edge portion along a terminal portion of the element substrate 10 and the sealant 40. Furthermore, an inspection circuit 103 is provided between the sealant 40 along a second edge portion facing the first edge portion and the pixel region E. Furthermore, a scan line drive circuit 102 is provided between the sealant 40 along third and fourth edge portions that are at a right angle to the first edge portion and face each other, and the pixel region E. Multiple segments of wiring 105 that link two of the scan line drive circuits 102, are provided between the sealant 40 along the second edge portion, and the inspection circuit 103.

The wiring, which links the data line drive circuits 101 and the scan line drive circuit 102 is connected to multiple external connection terminals 104 arranged along the first edge portion. Descriptions are provided below, with a direction along the first edge portion being defined as an X direction (equivalent to a first direction according to the invention) and a direction along the third edge portion being defined as a Y direction (equivalent to a second direction according to the invention). In addition, an arrangement of the inspection circuit 103 is not limited to this arrangement and the inspection circuit 103 may be provided in a position inside the sealant 40 between the data line drive circuit 101 and the pixel region E.

As illustrated in FIG. 1B, a transparent pixel electrode 15 and a thin film transistor 30 (hereinafter referred to as TFT) that is a switching element, which are provided in every pixel P, signal wiring, and an orientation film 18 covering these are formed on a surface of the element substrate 10, which faces toward the liquid crystal layer 50. Furthermore, in TFT 30, a light blocking construction is adopted that prevents light incident on a semiconductor layer from causing a witching operation to be unstable. The element substrate 10 as a first substrate according to the invention includes at least the base substrate 10s, the pixel electrode 15, TFT 30, the signal wiring, and the orientation film 18 that are formed on the substrate 10s.

The opposite substrate 20, arranged opposite to the element substrate 10, as a second substrate according to the invention, includes at least the base substrate 20s, the parting unit 21 formed on the substrate 20s, a planarization layer 22 that is film-formed in such a manner as to cover the parting unit 21, a common electrode 23 that is provided in such a manner as to cover the planarization layer 22, and an orientation film 24 covering the common electrode 23.

The parting unit 21 not only surrounds the pixel region E as illustrated in FIG. 1A, but is also provided in a position that overlaps with the scan line drive circuit 102 and the inspection circuit 103, when viewed from above. This plays a role in blocking light from the opposing substrate 20 being incident on a peripheral circuit including the drive circuit, and thereby preventing the peripheral circuit from malfunctioning due to the light. Furthermore, a high contrast is secured in a display in the pixel region E by blocking unnecessary stray light in such a manner that it cannot be incident on the pixel region E.

The planarization layer 22 is made from, for example, an inorganic material such as silicon oxide, and has optical transparence, and is provided in such a manner as to cover the parting unit 21. A method of forming a film using a plasma CVD technique is enumerated as a method of forming such a planarization layer 22.

The common electrode 23 is made from, for example, a transparent conductive film such as indium tin oxide (ITO). The common electrode 23 not only covers the planarization layer 22, but is also electrically connected to the wiring that faces toward the element substrate 20, due to top and bottom conductive portions 106 provided at four corners of the opposite substrate 10, as illustrated in FIG. 1A.

The orientation film 18 that covers the pixel electrode 15, and the orientation film 24 that covers the common electrode 23 are selected based on an optical design of the liquid crystal device 100. For example, an organic orientation film and an inorganic orientation film are enumerated. The organic orientation film is formed by film-forming an organic material such as polyimide, then rubbing a surface of the formed film and thus performing substantially horizontal orientation processing with respect to a crystal molecule having positive dielectric anisotropy. The inorganic orientation film is formed by film-forming an inorganic material such as SiOx (silicon oxide) through the use of a vapor growth technique and then performing substantially vertical orientation processing with respect to a liquid crystal molecule having negative dielectric anisotropy. According to the first embodiment, the liquid crystal layer 50 is configured from liquid crystal molecule having negative dielectric anisotropy, with the inorganic orientation film being used as the orientation films 18 and 24.

Such a liquid crystal device 100 is a transmission type, and the optical design is adopted that requires a normal white mode in which the pixel P is a bright display during non-drive and a normal black mode in which the pixel P is a dark display during non-drive. A polarization element is arranged for use in each of the direction of incoming light and the direction of outgoing light, according to the optical design. According to the first embodiment, the normal black mode is adopted.

Next, an electrical configuration of a liquid crystal device 100 is described referring to FIG. 2. The liquid crystal device 100 has multiple scan lines 3a and multiple data lines 6a, as signal lines, which are insulated from one another and are at a right angle to one another, at least in the pixel region E, and capacity lines 3b that are arranged in parallel with one another, along the data lines 6a. The direction in which the scan line 3a extends is an X direction, and the direction in which the data line 6a extends is a Y direction.

The scan line 3a, the data line 6a and the capacity line 3b, and the pixel electrode 15, TFT 30 and the storage capacitance 16 are provided in a region partitioned by these types of signal lines make up a pixel circuit of the pixel P.

The scan line 3a is electrically connected to a gate of TFT 30, and the data line 6a is electrically connected to first source and drain regions of TFT 30. The pixel electrode 15 is electrically connected to second source and drain regions of TFT 30.

The data line 6a is connected to the data line drive circuit 101 (refer to FIG. 1) and supplies image signals D1, D2, and so forth up to Dn supplied from the data line drive circuit 101 to the pixel P. The scan line 3a is connected to the scan line drive circuit 102 (refer to FIGS. 1A and 1B) and supplies scan signals SC1, SC2, and so forth up to SCm supplied from the scan line drive circuit 102 to each pixel P.

The image signals D1 to Dn to be supplied from the data line drive circuit 101 to the data lines 6a may be supplied in this sequence, in a line sequence, and the image signals D1 to Dn may be supplied with respect to every group, each group consisting of the multiple data lines 6a that are adjacent to one another. The scan line drive circuit 102 supplies the scan signals SC1 to SCm with respect to the scan lines 3a, in the shape of a pulse, at a predetermined timing, in the line sequence.

The liquid crystal device 100 has a configuration in which the image signals D1 to Dn supplied from the data line 6a are written to the pixel electrodes 15 at the predetermined timing, because TFT 30, the switching element, is in an ON state only for a certain period of time due to input of the scan signals SC1 to SCm. Then, the image signals D1 to Dn at a predetermined level that are written to the liquid crystal layer 50 through the pixel electrodes 15 are maintained between the pixel electrode 15 and the common electrode 23 that is arranged opposite to the pixel electrode 15, with the liquid crystal layer 50 in between, for a certain period of time.

In order to prevent the maintained image signals D1 to Dn from leaking, a storage capacitance 16 is connected in parallel with a liquid crystal capacity that is formed between the pixel electrode 15 and the common electrode 23. The storage capacitance 16 is provided between the second source and drain regions of TFT 30 and the capacity line 3b.

Moreover, the configuration is provided in which the data line 6a is connected to the inspection circuit 103 illustrated in FIG. 1A, and in a process of manufacturing the liquid crystal device 100, for example, an operational defect of the liquid crystal device 100 can be checked by detecting the image signal described above, but this configuration is omitted in an equivalent circuit in FIG. 2.

Furthermore, the inspection circuit 103 may include a sampling circuit that samples the image signal described above and supplies the result to the data line 6a, and a precharge circuit that supplies a precharge signal at a predetermined level of voltage to the data line 6a in advance of the image signal.

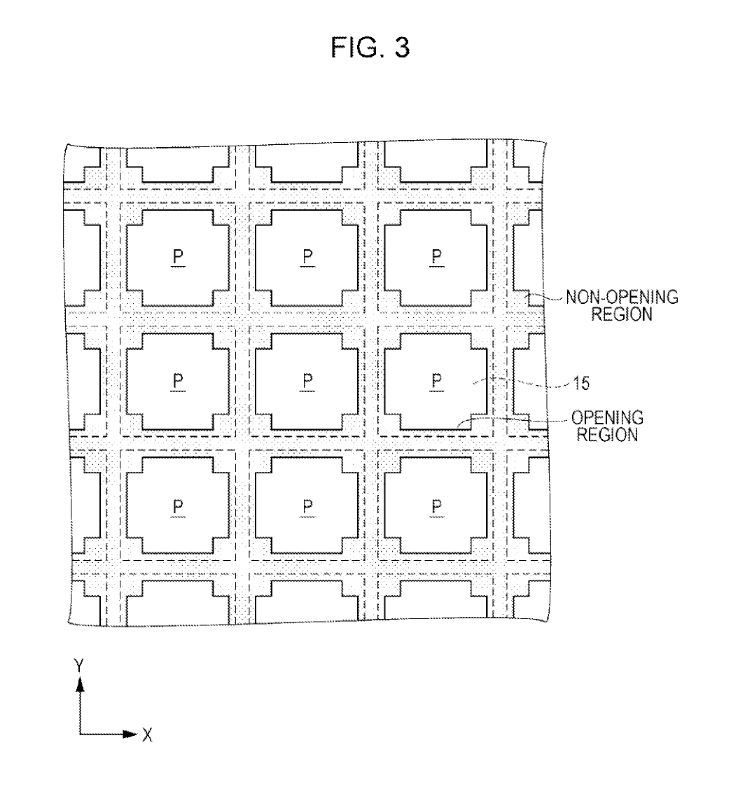

Next, an arrangement of the pixels P is described referring to FIG. 3. FIG. 3 is a schematic plan view illustrating the arrangement of the pixels in the liquid crystal device.

As illustrated in FIG. 3, the pixel P in the liquid crystal device 100 has, for example, a substantially rectangular opening region when viewed from above. The opening region is surrounded by a non-opening region (referred to as the light blocking region) with a light blocking property, which extends in the X direction and in the Y direction, and are provided in the shape of a lattice. The pixel electrode 15 provided in the opening region in every pixel P is arranged in such a manner that the edge thereof extends over the non-opening region (the light blocking region).

The scan line 3a, illustrated in FIG. 2, is provided in the non-opening region (the light blocking region) that extends in the X direction. A conductive member with a light blocking property is used as the scan line 3a, and the scan line 3a makes up at least one part of the non-opening region (a light blocking region).

Similarly, the data line 6a and the capacity line 3b, which are illustrated in FIG. 2, are provided in the non-opening region (the light blocking region) that extends in the Y direction. The conductive member with the light blocking property is used also as the data line 6a and the capacity line 3b, and the data line 6a and the capacity line 3b make up at least one part of the non-opening region (the light blocking region).

Not only the type of signal line provided to the side of the element substrate 10, but also a light blocking portion, patterned after a lattice to the side of the opposite substrate 20, can make up the non-opening region (the light blocking region).

TFT 30 and the storage capacitance 16, which are illustrated in FIG. 2, are provided in the vicinity of an intersection portion of the lattice-shaped non-opening region (the light blocking region). The provision of TFT 30 in the vicinity of the intersection portion of the non-opening region (the light blocking region) with the light blocking property not only prevents TFT 30 from malfunctioning in terms of light, but also secures an opening rate in the opening region. In relation to the provision of TFT 30 and the storage capacitance 16 in the vicinity of the intersection portion described above, the width of the non-opening region (the light blocking region) in the vicinity of the intersection portion described above is broader than that of the other parts.

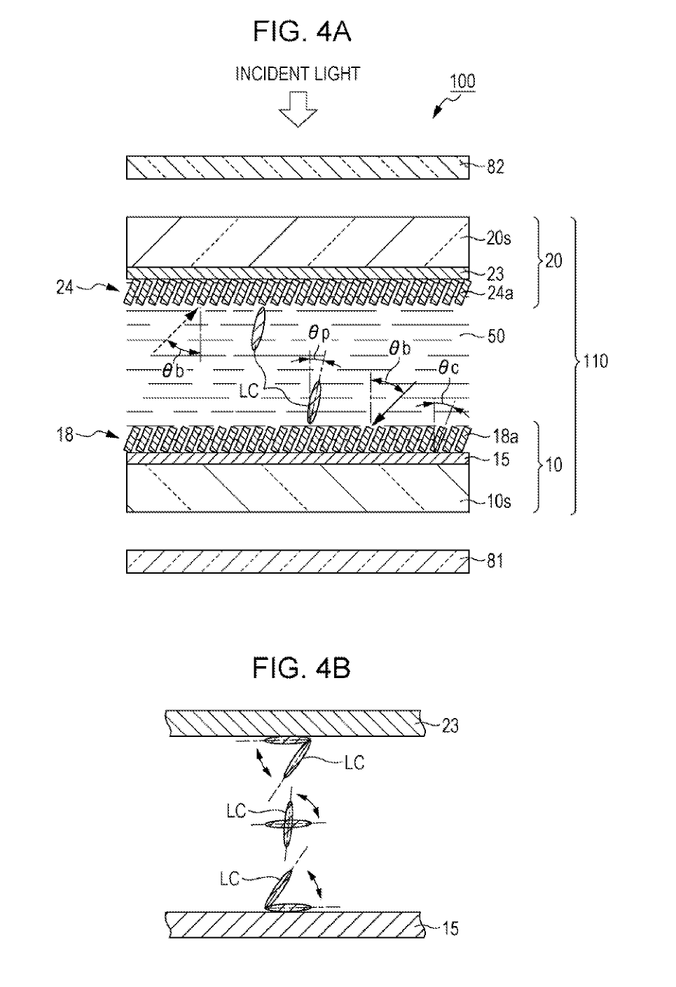

Then, an oriented state of the liquid crystal molecule in the liquid crystal device 100 is described referring to FIGS. 4A and 4B. FIG. 4A is a schematic cross-sectional view illustrating a formed state of an inorganic orientation film and the oriented state of the liquid crystal molecule in the liquid crystal device, and FIG. 4B is a schematic diagram illustrating a behavior of the liquid crystal molecule.

As illustrated in FIG. 4A, on surfaces of the pixel electrode 15 and the common electrode 23 in the liquid crystal device 100, the orientation film 18 and the orientation film 24 are formed that are obtained by depositing silicon oxide in an oblique manner using a vacuum deposition technique, which is one example of a physical vapor growth technique. Specifically, a deposition angular degree θb with respect to a normal line of the surface of the substrate in contact with the liquid crystal layer 50 is approximately 45 degrees. A crystal substance of silicon oxide is grown on the surface of the substrate in the form of a column toward the deposition direction, by using such an oblique deposition. Such column-shaped crystal substances are referred to as columns 18a and 24a. The orientation films 18 and 24 are an aggregate of columns 18a, and an aggregate of columns 24a, respectively. Furthermore, an angular degree θc of the growth direction of the columns 18a and 24a with respect to the normal line of the surface of the substrate is not necessarily consistent with the deposition angular degree θb, and in such a case, is approximately 20 degrees.

A pre-tilt angle θp of a liquid crystal molecule LC that is oriented vertically with respect to the surfaces of the orientation films 18 and 24 approximately ranges from 3 degrees to 5 degrees. Furthermore, the pre-tilt direction in which the liquid crystal molecule LC is inclined when viewed from the normal line direction of the surface of the substrate, that is, an inclination direction, is the same as the direction of the oblique deposition, when viewed from above, in the orientation films 18 and 24. The inclination direction, described above, of the vertical orientation processing is appropriately set based on an optical design requirement for the liquid crystal device 100.

The oriented state in which the liquid crystal molecule LC with the negative dielectric anisotropy with respect to such a surface of the orientation film is given the pre-tilt angle θp and thus stands upside down is referred to as a substantially vertical orientation.

What is made from the element substrate 10 and the opposite substrate 20, arranged opposite to each other and the liquid crystal layer 50 interposed between and supported by a pair of the substrates is referred to as a liquid crystal panel 110. The liquid crystal device 100 has polarization elements 81 and 82, which are arranged to the side of the liquid crystal panel 110 that is in the direction of the incoming light and to the side of the liquid crystal panel 110 that is in the direction of the outgoing light, respectively, in order to be used. Furthermore, each of the polarization elements 81 and 82 is arranged with respect to the liquid crystal panel 110, in such a manner that a transmission axis or an absorption axis of one of the polarization elements 81 and 82 is in parallel with respect to the X direction and the Y direction, and further in such a manner that both of the transmission axes or both of the absorption axes are at a right angle to each other.

According to the first embodiment, in the pixel region E, the substantially vertical orientation processing is performed, in such a manner that a pre-tilt azimuth angle of the liquid crystal molecule LC with respect to the transmission axes or the absorption axes of the polarization elements 81 and 82 is 45 degrees. Therefore, when a drive voltage is applied between the pixel electrode 15 and the common electrode 23 to drive the liquid crystal layer 50, as illustrated in FIG. 4B, the liquid crystal molecule LC falls down in the pre-tilt inclination direction and thus is in an optical arrangement in which high transmissivity is obtained.

When the driving (ON/OFF) of the liquid crystal layer 50 is repeated, the liquid crystal molecule LC repeats the behavior of falling down in the pre-tilt inclination direction, or returning to an initial oriented state. The substantially vertical orientation processing that causes such a behavior of the liquid crystal molecule LC is referred to as the substantially vertical orientation processing relating to a first axis.

Moreover, as illustrated in FIG. 4A, an incident direction of light with respect to the liquid crystal panel 110 is not limited to the direction in which light is incident on the liquid crystal panel 110 from the side of the opposite substrate 20. Furthermore, a configuration may be possible in which an optical compensation element, such as a phase difference plate, is provided in the direction of the incoming light or in the direction of the outgoing light.

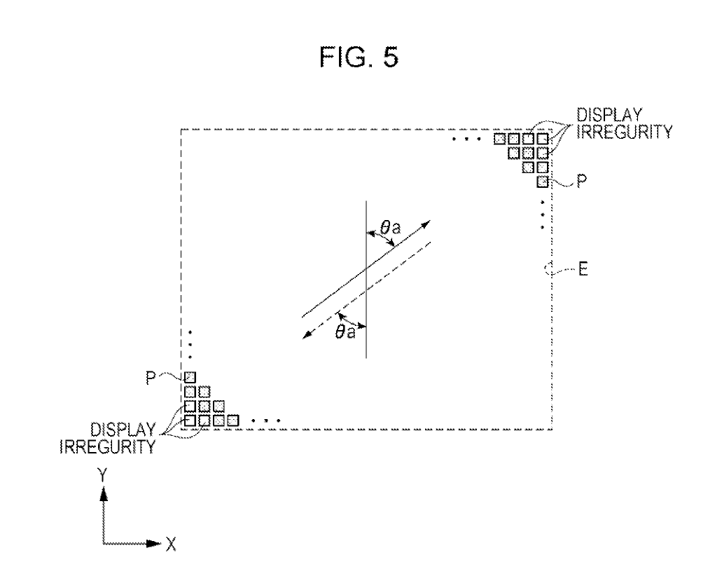

Then, a display irregularity, resulting from the uneven distribution of the ionic impurities, which the invention is going to solve, is described referring to FIG. 5. FIG. 5 is a schematic plan view illustrating one example of the display irregularity entailed by the uneven distribution of the ionic impurities. Moreover, FIG. 5 illustrates a case where the optical design of the liquid crystal device is for the normal black.

As illustrated in FIG. 5, the pre-tilt inclination direction of the liquid crystal molecule LC in the pixel region E is set in such a manner that the azimuth angle θa that ends up matching the Y direction is 45 degrees. Specifically, an arrow direction indicated by a broken line is a direction of the oblique deposition with respect to the element substrate 10 and is a direction of motion from upper right to lower left. On the other hand, an arrow direction indicated by a solid line is the direction of the oblique deposition with respect to opposite substrate 20 arranged opposite to the element substrate 10 and is a direction of motion from lower left to upper right. The pre-tilt inclination direction of the liquid crystal molecule LC in such a pixel region E is referred to as an inclination direction θa, using the azimuth angle θa as it is.

According to such an inclination direction θa, the behavior of the liquid crystal molecule LC arranged substantially vertically oriented with respect to the surface of the substrate being shaken in the inclination direction θa is shown by driving the pixel P (refer to FIG. 4B). This causes the behavior, that is, a flow of the liquid crystal molecule LC toward the inclination direction θa, and thus the ionic impurities included in the liquid crystal layer 50 is moved into the liquid crystal layer 50, along the flow, and is soon transported to a corner portion positioned in the inclination direction θa of the pixel region E, resulting in an occurrence of the uneven distribution of the ionic impurities. When this is done, as illustrated in FIG. 5, for example, the display irregularity, such as ghosting and luminance irregularity, resulting from the uneven distribution of the ionic impurities, occurs in the corner portion of the pixel region E. More specifically, for example, in a case of the normal black, the pixel P positioned in the corner portion described above is decreased in drive electric potential by the uneven distribution of the ionic impurities, and thus light leakage occurs, resulting in a decrease in contrast. FIG. 5 illustrates a state in which the light leakage occurs in the three pixels P positioned in the corner portion of the pixel region E.

In addition, the inclination direction θa of 45 degrees may be such that not only rightward rising inclination is at 45 degrees, but rightward falling inclination is also at 45 degrees, as illustrated in FIG. 5, and in such a case, the display irregularity occurs in the lower left and upper right corner portions of the pixel region E in FIG. 5. That is, the inclination direction θa of the liquid crystal molecule LC when the drive voltage is applied to the liquid crystal layer 50 becomes a flow direction of the liquid crystal molecule LC. In addition, the thickness of the liquid crystal layer 50 depends on a liquid crystal material being used, but it is approximately in a range of 2 μm to 3 μm, and the flow of the liquid crystal molecule LC strongly occurs in the vicinity of the orientation film surface of the orientation films 18 and 24. Thus, the flow direction of the liquid crystal molecule LC is reversed on the side of the element substrate 10 and the side of the opposite substrate 20.

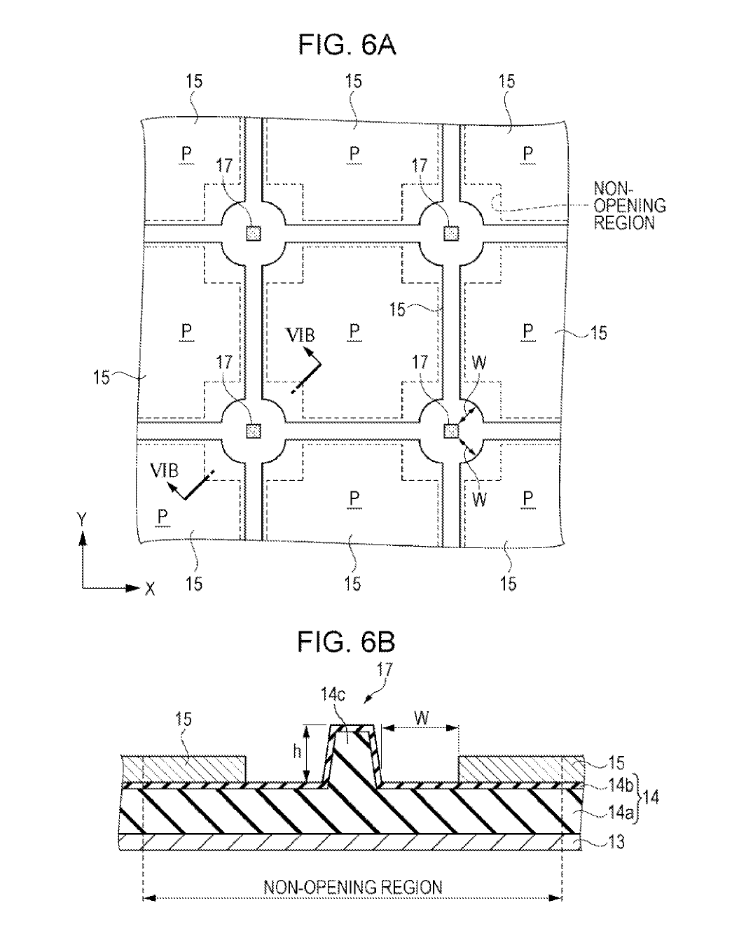

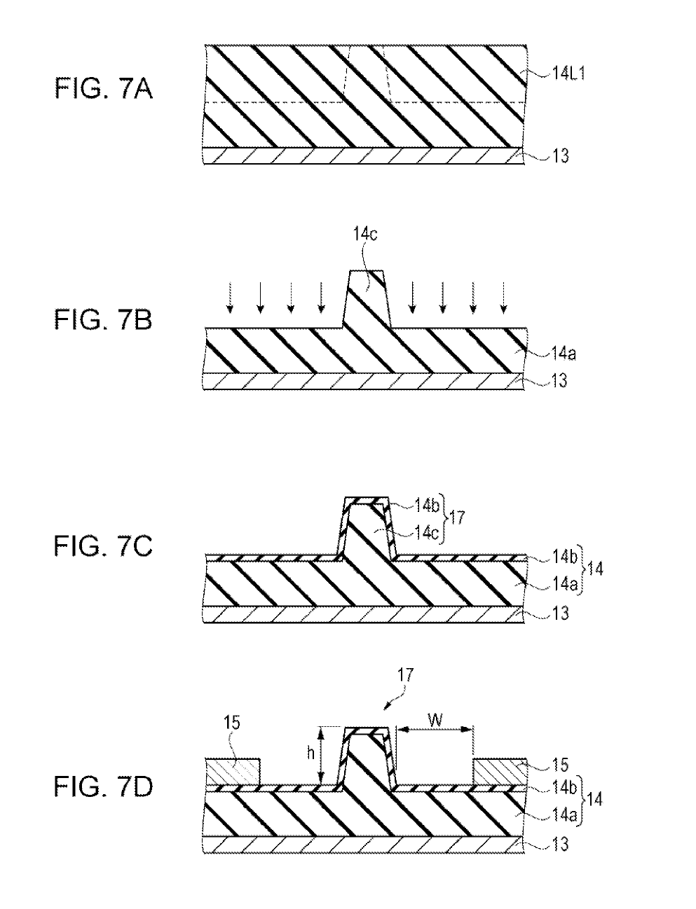

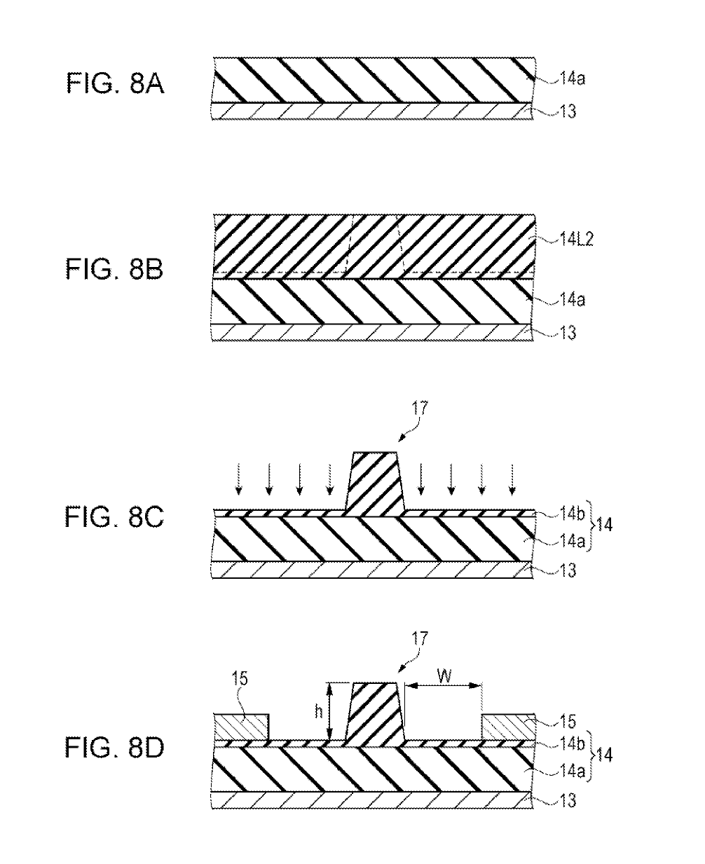

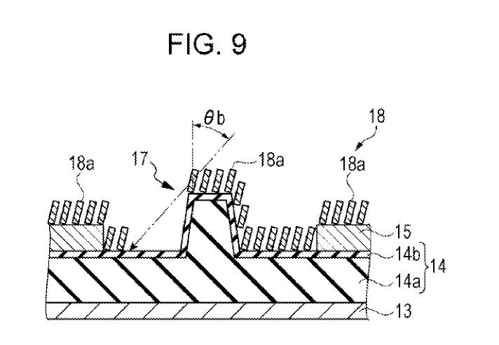

The inventor developed the liquid crystal device 100 for the purpose of improving the display irregularity of the corner portion of the pixel region E due to the uneven distribution of the ionic impurities. Specifically, the protrusion portion that impedes the flow of the liquid crystal molecule LC described above is provided an inter-layer insulating film between the pixel electrodes 15, and thus the uneven distribution of the ionic impurities in the liquid crystal layer 50 is suppressed. A configuration of the protrusion portion in the liquid crystal device 100 according to the first embodiment is described below, referring to FIGS. 6A to 9. FIG. 6A is a schematic plan view illustrating the configuration of the protrusion portion, and FIG. 6B is a schematic cross-sectional view, illustrating the configuration of the protrusion portion, which is taken along a line VIB-VIB across the protrusion portion in FIG. 6A. FIGS. 7A to 7D are schematic cross-sectional views, each illustrating a method of forming the protrusion portion. FIGS. 8A to 8D are schematic cross-sectional views, each illustrating another method of forming the protrusion portion. FIG. 9 is a schematic cross-sectional view illustrating the formed state of the orientation film in the vicinity of the protrusion portion.

As illustrated in FIG. 6A, a protrusion portion 17 is provided at a position equivalent to the center of the intersection portion of the non-opening region provided in the shape of a lattice. Therefore, the protrusion portion 17 is arranged that corresponds to the four corners of the pixel electrode 15 in the pixel P. In other words, the multiple (four) pixel electrodes 15 are arranged in the vicinity of the protrusion portion 17.

The protrusion portion 17 is substantially square (rectangular) when viewed from above. Furthermore, a spacing W, which has a constant size or greater, is provided between an end of the protrusion portion 17 and an edge (an end) of each pixel electrode 15. In order to provide the spacing W between the pixel electrode 15 and the protrusion portion 17, the substantially-square (rectangular) four corners of the pixel electrode 15 is cut into an arc shape. The spacing W between the protrusion portion 17 and the end of the protrusion portion 17 and the edge portion of the pixel electrode 15 is positioned inside the intersection portion of the non-opening region.

FIG. 6B is a schematic cross-sectional view, which is taken along the line VIB-VIB passing through the protrusion portion 17 at an inclination angle of 45 degrees from lower left to upper right in FIG. 6A. That is, the line VIB-VIB is along a deposition direction (the inclination direction (the flow direction) of the liquid crystal molecule LC) in the oblique deposition of the orientation film 18 in the element substrate 10.

As illustrated in FIG. 6B, the protrusion portion 17 is integrally formed on the inter-layer insulating film 14 form between an wiring layer 13 and the pixel electrode 15. An example of the specific formation method is described below, but the inter-layer insulating film 14 is formed by depositing a first insulating film 14a facing toward the wiring layer 13 and a second insulating film 14b facing toward the pixel electrode 15. A column portion 14c is formed in first insulating film 14a, and cover this column portion 14c, and second insulating film 14b is formed. That is, the protrusion portion 17 is configured from the column portion 14c and the second insulating film 14b.

The spacing W between the end of the protrusion portion 17 and the end of the pixel electrode 15 are set to be greater than a height h of the protrusion portion 17 on the inter-layer insulating film 14. Furthermore, the height h of the protrusion portion 17 is higher (greater) than a height of the pixel electrode 15 on the inter-layer insulating film 14. Specifically, for example, the height h of the protrusion portion 17 is approximately 300 nm to 500 nm. The spacing W is 400 nm to 600 nm. The height of the pixel electrode 15, that is, the thickness is approximately 50 nm to 200 nm.

As the method of forming such a protrusion portion 17, for example, as illustrated in FIG. 7A, first, an insulating film precursor 14L1 is formed by covering the wiring layer 13 on the base substrate 10s (an illustration thereof is omitted in FIGS. 7A to 7D). For example, the insulating film precursor 14L1 is a non-silicate glass (NSG) film and is an oxidation silicon film that results from growing a mixed gas of tetraethoxysilane (TEOS) and O₃ using a vapor phase growth deposition (CVD) technique that is performed under a normal pressure or under a near-normal pressure. The film thickness of the insulating film precursor 14L1 is 800 nm to 1,000 nm.

Next, as illustrated in FIG. 7B, the first insulating film 14a having the column portion 14c, the height of which is 250 nm to 450 nm, is formed by selectively etching the insulating film precursor 14L1. As the etching method, after layering etching resist to a portion corresponding to the column portion 14c, a liquid phase process of performing etching using a strong alkaline solution or a fluoric acid solution, or a vapor phase process (dry etching) of etching using fluorine system processing gas such as CF₄ can be enumerated. According to the first embodiment, the latter, the vapor phase process, is adopted.

As illustrated in FIG. 7C, the second insulating film 14b is formed in such a manner as to cover the column portion 14c. The second insulating film 14b, for example, a boron silicate glass (BSG) film, or a boron phosphor silicate glass (BPSG) film, and in the same manner as NSG film, can be formed using the vapor phase growth (CVD) technique that adds boron (B) or phosphorous (P) to the mixed gase described above. BSG film and BPSG film are good in terms of throwing power (film formation property) with respect to a surface having concavities and convexities, compared to NSG film, and can cover all over the column portion 14c. The film thickness of the second insulating film 14b is approximately 50 nm. Furthermore, BSG film and BPSG film have higher moisture absorption performance than NSG film. Because of this, the protrusion portion 17, the height of which is 300 nm to 500 nm, is formed in which the column portion 14c is covered with the second insulating film 14b.

Next, as illustrated in FIG. 7D, the transparent conductive film, such as ITO, is film-formed in such a manner that the film thickness is 50 nm to 200 nm to cover the protrusion portion 17, and the pixel electrode 15 is formed in every pixel P by performing the patterning on the resulting film using a photo lithography technique. As illustrated above, the pattering is performed on the transparent conductive film, in such a manner that the spacing W (refer to FIGS. 6A and 6B) between the end of the protrusion portion 17 and the end of the pixel electrode 15 are provided. Therefore, the patterning can be performed, in a desired shape, on the pixel electrode 15 that is difficult for the protrusion portion 17 to influence, compared to a case where the patterning is performed on the pixel electrode 15 in such a manner as to be close to the protrusion portion 17.

The method of forming the protrusion portion 17 is not limited to the formation method is illustrated in FIGS. 7A to 7D and a formation method illustrated in FIGS. 8A to 8D can be used.

For example, as illustrated in FIG. 8A, the first insulating film 14a is first film-formed that covers the wiring layer 13. For the first insulating film 14a, NSG film can be used that is formed using the vapor phase growth (CVD) technique, as illustrated above. The film thickness of the first insulating film 14a in such a case, for example, is 300 nm to 500 nm.

Next, as illustrated in FIG. 8B, a insulating film precursor 14L2 is film-formed by covering the first insulating film 14a. For the insulating film precursor 14L2, BSG film or BPSG film can be used that is formed using the vapor phase growth (CVD) technique, as illustrated above. The film thickness of the insulating film precursor 14L2 is 400 nm to 600 nm.

Then, as illustrated in FIG. 8C, the second insulating film 14b having the protrusion portion 17, the height of which is 300 nm to 500 nm, is formed by selectively etching the insulating film precursor 14L2. It is easy to perform the etching on BSG film and the BPSG film, using the liquid phase process and the gas phase process, compared to NSG film, and there is an advantage in that the protrusion portion 17 is easy to form.

Next, as illustrated in FIG. 8D, the transparent conductive film is film-formed in such a manner as to cover the second insulating film 14b, and the pixel electrode 15 is patterning-formed in such a manner that the spacing W (refer to FIGS. 6A and 6B) is formed between the pixel electrode 15 and an end portion of the protrusion portion 17.

The method of forming the protrusion portion 17 is described referring to FIGS. 7A to 7D and 8A to 8D, but in a case where the protrusion portion 17 is integrally formed on the inter-layer insulating film 14 by etching the insulating film precursors 14L1 and 14L2, a final shape of the protrusion portion 17 is determined depending on which etching process is used. Particularly, in the liquid phase process in which an isotropic etching is performed, the planar shape of the protrusion portion 17 is not rectangular as illustrated in FIG. 6A, but is in a near-round shape in which the corner portion is roundish. Furthermore, the bottom surface of the cross-sectional shape of the protrusion portion 17, which is in the direction of the wiring layer 13, is in the shape of a large trapezoid, in relation to a progress direction of the etching in both of the liquid phase process and the vapor phase process.

The provision of the spacing W between the end of the protrusion portion 17 and the end of each pixel electrode 15 not only makes the performance of the pattering on the pixel electrode 15 easy, but also offers the following advantages. The description is provided below, referring to FIG. 9.

As illustrated in FIG. 9, the orientation film 18 is formed in such a manner as to cover the pixel electrode 15. The orientation film 18 is configured from a column (a columnar crystal) 18a that is obtained by depositing inorganic material such as silicon oxide at the deposition angle θb (45 degrees) in an oblique manner, as described above. Therefore, in the vicinity of the protrusion portion 17, a part occurs, that becomes a shadow with respect to the deposition direction, and the column 18a is difficult to grow in the part that becomes the shadow. Since the spacing W described above is greater than the height h of the protrusion portion 17, when the deposition angular degree θb is at least 45 degrees or below, the part where the column 18a is difficult to grow does not occur in the pixel electrode 15. That is, the orientation film 18 can be certainly formed in such a manner that the pixel electrode 15 is covered in the vicinity of the protrusion portion 17. That is, there is an advantage in that orientation disorder of the liquid crystal molecule LC resulting from a film formation irregularity in the orientation film 18 is difficult to occur in the opening region with the pixel electrode 15.

On the other hand, the greater the height h of the protrusion portion 17, the greater an effect of impeding the flow of the liquid crystal molecule LC, but a range is increased in which the film formation irregularity of the orientation film 18 occurs. Therefore, from the perspective that the film formation irregularity does not have to propagate to the opening region, in other words, that the orientation disorder of the liquid crystal molecule LC has to be held within the non-opening region, it is desirable that the height h of the protrusion portion 17 is greater than the pixel electrode 15 on the inter-layer insulating film 14 and additionally is 1 μm or less.

In addition, the orientation film 18 that covers the pixel electrode 15 is not limited to the inorganic orientation film, and an organic orientation film may be used, such as polyimide resin. Also in a case where the orientation processing is performed by performing rubbing processing on the organic orientation film, it is possible to decrease the propagation of the orientation disorder of the liquid crystal molecule LC, resulting from the rubbing processing being not sufficiently performed in the vicinity of the protrusion portion 17, to the pixel electrode 15 (the opening region).

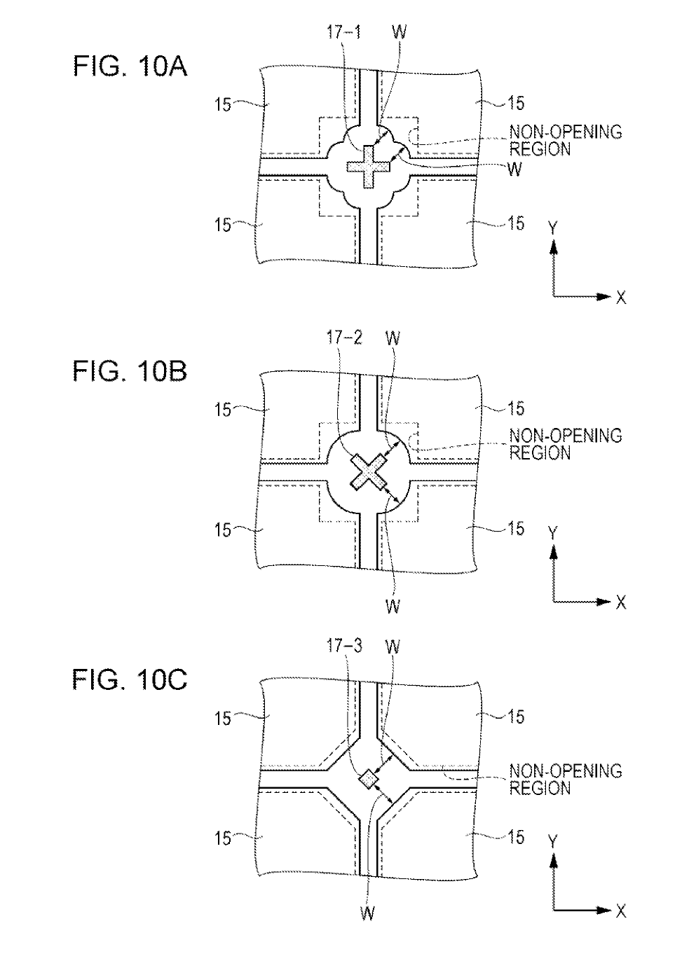

Next, another configuration example of the protrusion portion 17 is described, referring to FIG. 10A to 10C. FIGS. 10A to 10C are schematic plan views, each illustrating another configuration example of the protrusion portion.

The planar shape of the protrusion portion 17 is not limited to a rectangle (a polygon), a circle or an ellipse, and, for example, as illustrated in FIG. 10A, the protrusion portion 17-1 may have a part that extends in the X direction (the first direction) and a part that extends in the Y direction (the second direction), may have the shape of a cross in which the parts intersects. The predetermined spacing V is provided between the end of the pixel electrode 15 and the protrusion portion 17-1 in the shape of a cross. According to such a cross shape, it is possible to effectively impede the flow of liquid crystal molecule LC that occurs in the substantially vertical orientation processing direction relating to the first axis, described above.

Furthermore, even though such a cross shape does not necessarily have a part along the X direction, or the Y direction, for example, as a protrusion portion 17-2 illustrated in FIG. 10B, a configuration may be provided in which the protrusion portion 17-1 is rotated by 45 degrees in such a manner as to have a part intersecting the flow direction of the liquid crystal molecule LC.

Furthermore, as a protrusion portion 17-3 illustrated in FIG. 10C, a configuration may be provided in which the protrusion portion 17 is arranged with it being rotated by 45 degrees, in such a manner that at least one side portion faces (intersects) the flow diction of the liquid crystal molecule LC. In FIG. 10C, the intersection portion of the non-opening region has a configuration in which the intersection portion has side portions inclined with respect to the X direction and the Y direction, in such a manner as to be matched with the shape of the corner portion of the pixel electrode 15.

According to this, an area of the non-opening region is decreased in the intersection portion, compared to the cross shapes in FIGS. 10A and 10B and thus an area of the opening region can be increased. That is, the opening ratio of the pixel P is improved. In other words, even though the intersection portion of the non-opening region is decreased, the protrusion portion 17-3 can be provided in which the display irregularity resulting from the ionic impurities can be effectively decreased.

The effects according to the first embodiment are as follows.

(1) The liquid crystal device 100 has the protrusion portion 17 of the inter-layer insulating film 14 between the pixel electrode 15 and adjacent pixel electrode 15. Furthermore, the height h of the protrusion portion 17 is higher than a height h (a film thickness) of the pixel electrode 15 on the inter-layer insulating film 14. Therefore, the flow of the liquid crystal molecule LC entailed by the drive of the liquid crystal layer 50 is impeded by the protrusion portion 17, and this can decrease the display irregularity caused by the uneven distribution of the ionic impurities resulting from the flow described above in the corner portion of the pixel region E. Consequently, the liquid crystal device 100 can be provided that has a display quality excellent in terms of decreasing the display irregularity resulting from the ionic impurities.

(2) Besides, the spacing W between the end of the protrusion portion 17 and the end of each pixel electrode 15 is greater than the height h of the protrusion portion 17 on the inter-layer insulating film 14. Therefore, it is easy to perform the patterning on the pixel electrode 15 to a predetermine shape, compared to a case where the pixel electrode 15 is formed in such a manner to be close to the protrusion portion 17. Then, even though the orientation film 18 is formed on the pixel electrode 15 using the oblique deposition, the film formation irregularity resulting from the protrusion portion 17 does not propagate to the pixel electrode 15 (the opening region). That is, the display is not influenced.

(3) Since the spacing W between the protrusion portion 17 and the end of the protrusion portion 17 and the end of each pixel electrode 15 is positioned inside the intersection portion of the non-opening region (the light blocking region), even though the light leakage resulting from the orientation disorder of the liquid crystal molecule LC occurs in the vicinity of the protrusion portion 17, light is blocked and thus it is possible to make it difficult for the light leakage to be noticeable. The decrease in the contrast entailed by the light leakage can be prevented.

(4) The protrusion portion 17 is integrally formed on the inter-layer insulating film 14, and the inter-layer insulating film 14 is configured from the first insulating film 14a and the second insulating film 14b that has higher moisture absorption performance than the first insulating film 14a. Since the second insulating film 14b faces the liquid crystal layer 50, even though water penetrates from the outside, the second insulating film 14b absorbs the water, and thus the decrease in the display grade due to the water can be suppressed. That is, the liquid crystal device 100 can be provided that has a high-reliability quality.

### Second Embodiment

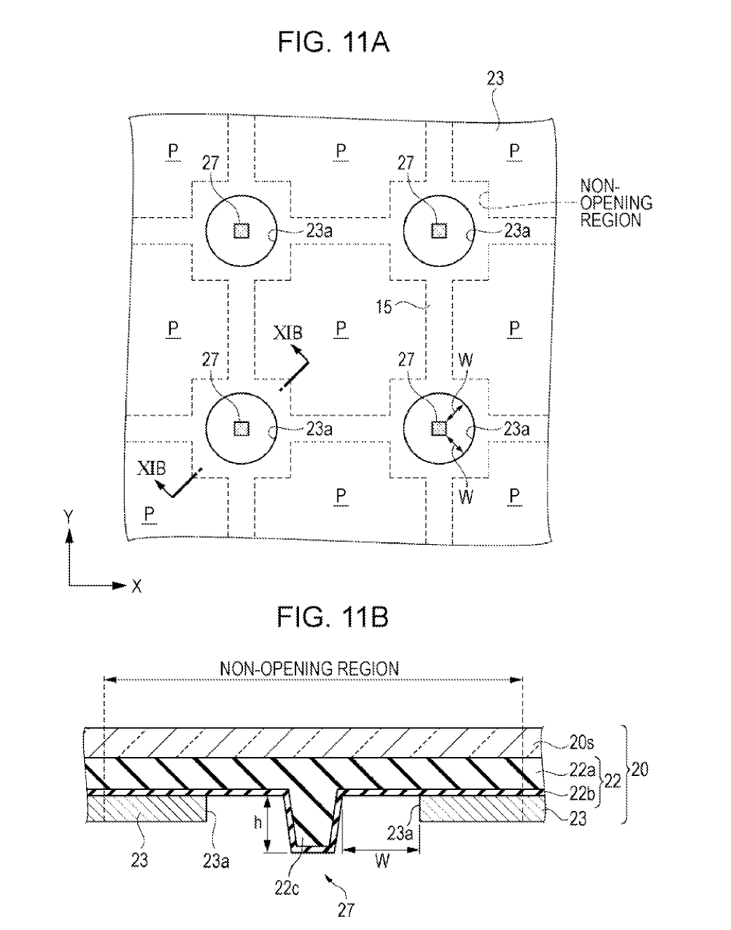

Next, a liquid crystal device according to a second embodiment is described referring to FIGS. 11A and 11B. FIG. 11A is a schematic plan view illustrating a configuration of a protrusion portion in the liquid crystal device according to the second embodiment, and FIG. 11B is a schematic cross-sectional view that is taken along a line XIB-XIB passing through the protrusion portion at an inclination angle of 45 from lower left to upper right in FIG. 11A. That is, the line XIB-XIB is along a deposition direction (an inclination direction (a flow direction) of the liquid crystal molecule LC)) in an oblique deposition of an orientation film 18 in an element substrate 10.

The liquid crystal device according to the second embodiment is a liquid crystal device that results from providing the protrusion portion on the side of the opposite substrate 20 in the liquid crystal device 100 according to the first embodiment. Therefore, the same configurations as that according to the first embodiment are given like reference numerals, and the detailed descriptions thereof are omitted.

As illustrated in FIGS. 11A and 11B, a protrusion portion 27 in the liquid crystal device according to the second embodiment is provided in an opening portion 23a of a common electrode 23 on an opposite substrate 20. More specifically, the common electrode 23 has the circle-shaped opening portions 23a that are formed to correspond to every intersection portion of a non-opening region. The protrusion portion 27 is formed on a planarization layer 22 as an inter-layer insulating film of the opening portion 23a. The planarization layer 22 includes a first insulating film 22a and a second insulating film 22b that are formed on a base substrate 20s. The first insulating film 22a has a column portion 22c, the cross-section of which is formed, in a shape of a trapezoid, in a position corresponding to the opening portion 23a. The column portion 22c is obtained by selectively etching an insulating film precursor that is made, for example, from NSG film. The second insulating film 22b is made from, for example, a BSG film or a BPSG film, and is formed in such a manner as to cover the first insulating film 22a and the column portion 22c. The protrusion portion 27 is configured from the column portion 22c and the second insulating film 22b that covers the column portion 22c. The common electrode 23 is made from, for example, an ITO film. After being film-formed in such a manner as to cover a surface of the planarization layer 22 including the protrusion portion 27, the ITO film is selectively etched in such a manner that the protrusion portion 27 is exposed to be inside the opening portion 23a. Then, the patterning is performed on the resulting ITO film.

As illustrated in FIG. 11B, a spacing W between an end of the opening portion 23a and an end of the protrusion portion 27 is greater than a height h of the protrusion portion 27 on the planarization layer 22. The height h of the protrusion portion 27 is 1 μm or less and, for example, is 300 nm to 500 nm. The spacing W is 400 nm to 600 nm. A height, that is, a film thickness, of the common electrode 23 is approximately 50 nm to 200 nm. Furthermore, the protrusion portion 27 and the opening portion 23a are formed in such a manner as to overlap with the intersection portion of the non-opening region when viewed from above.

In addition, a planar shape of the protrusion portion 27 is not limited to a rectangle, and like the protrusion portion 17-1 and the protrusion portion 17-2 according to the first embodiment, may be in the shape of a cross that has parts extending in the X direction and in the Y direction. Furthermore a planar shape of the opening portion 23a is not limited to a circle and as long as the spacing W is secured between the opening portion 23a and the end of the protrusion portion 27, may be a polygon.

The effects according to the second embodiment are as follows.

(5) The liquid crystal device according to the second embodiment has the protrusion portion 27 on the planarization layer 22 of the opening portion 23a of the common electrode 23. Furthermore, the height h of the protrusion portion 27 is higher than the height of the common electrode 23 on the planarization layer 22. Therefore, the protrusion portion 27 impedes the flow of the liquid crystal molecule LC entailed by the drive of the liquid crystal layer 50, and thus an occurrence of the display irregularity can be decreased that results from the uneven distribution of the ionic impurities in the corner portion of the pixel region E due to the flow described above. Consequently, the liquid crystal device according to the second embodiment can be provided that has a display quality excellent in terms of decreasing the display irregularity resulting from the ionic impurities.

(6) Besides, the spacing W between the end of the protrusion portion 27 and the end of opening portion 23a is greater than the height h of the protrusion portion 27 on the planarization layer 22. Therefore, it is easy to perform the patterning on the common electrode 23 to a predetermined shape, compared to a case where the common electrode 23 is formed in such a manner to be close to the protrusion portion 27. Then, even though the orientation film 24 is formed on the common electrode 23 using the oblique deposition, the film formation irregularity resulting from the protrusion portion 27 does not propagate to the common electrode 23 (the opening region). That is, the display is not influenced.

(7) Since the spacing W between the protrusion portion 27 and the end of the opening portion 23a and the end of the protrusion portion 27 is positioned inside the intersection portion of the non-opening region (the light blocking region), even though the light leakage resulting from the orientation disorder of the liquid crystal molecule LC occurs in the vicinity of the protrusion portion 27, light is blocked and thus it is possible to make it difficult for the light leakage to be noticeable. The decrease in contrast entailed by the light leakage can be prevented.

(8) The protrusion portion 27 is integrally formed on the planarization film 22 as an inter-layer insulating film, and the planarization film 22 is configured from the first insulating film 22a and the second insulating film 22b that has higher moisture absorption performance than the first insulating film 22a. Since the second insulating film 22b faces the liquid crystal layer 50, even though water penetrates from the outside, the second insulating film 22b absorbs the water, and thus the decrease in the display quality due to the water can be suppressed. That is, the liquid crystal device according to the second embodiment can be provided that has a high reliability quality.

### Third Embodiment

### Electronic Apparatus

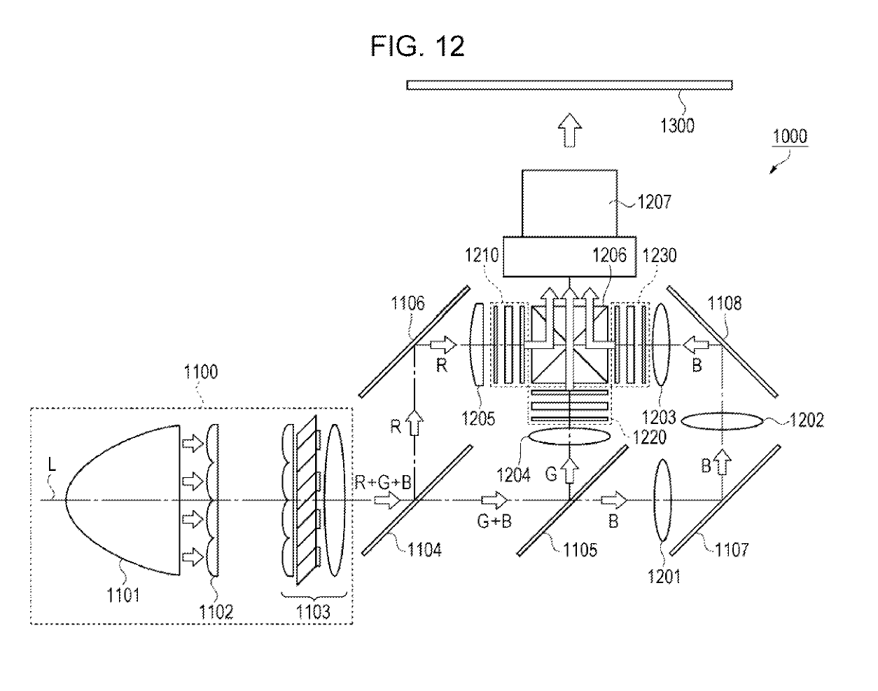

Next, an electronic apparatus according to a third embodiment is described referring to FIG. 12. FIG. 12 is a schematic diagram illustrating a configuration of a projection type display apparatus as an electronic apparatus.

As illustrated in FIG. 12, a projection type display apparatus 1000 as the electronic apparatus according to the third embodiment includes a polarized-light emission device 1100 that is arranged along a system optical axis L, two dichroic mirrors 1104 and 1105, as light separation elements, three reflection mirrors 1106, 1107, and 1108, five relay lenses 1201, 1202, 1203, 1204, and 1205, transmission type liquid crystal light valves 1210, 1220, and 1230, as three light modulation units, cross dichroic prism 1206, as a photosynthesis element, and a projection lens 1207.

The polarized-light emission device 1100 is mainly configured from a lamp unit 1101, as a light source that is made from a white light source, such as an ultrahigh pressure mercury lamp, or a halogen lamp, an integrator lens 1102, and a polarized-light conversion element 1103.

Of the luminous flux of polarized light emitted from the polarized-light emission device 1100, the dichroic mirror 1104 reflects red color (R) and allows green light (G) and blue light (B) to penetrate. The other dichroic mirror 1105 reflects the green light (G) that penetrates through the dichroic mirror 1104, and allows the blue light (B) to penetrate.

After being reflected from the dichroic mirror 1104, the red light (R) is reflected from the reflection mirror 1106 and then is incident on the liquid crystal light valve 1210 via the relay lens 1205.

After being reflected from the dichroic mirror 1105, the green light (G) is incident on the liquid crystal light valve 1220 via the relay lens 1204.

The blue light (B) that penetrates through the dichroic mirror 1105 is incident on the liquid crystal light valve 1230 via a light guide system that is made from the three relay lens 1201, 1202, and 1203 and the two reflection mirrors 1107 and 1108.

The liquid crystal light valves 1210, 1220, and 1230 are arranged opposite to incident surfaces of a cross dichroic prism 1206 that correspond to the color light, respectively. The color lights that are incident on the liquid crystal light valve 1210, 1220, and 1230 are modulated based on image information (image signal) and are emitted toward the cross dichroic prism 1206. This prism is made from the attached four rectangular prisms, and a dielectric multilayer film that reflects the red light and a dielectric multilayer film that reflects the blue light are formed, in the shape of a cross, on the inside surface of the prism. The three color lights are synthesized by the dielectric multilayer films and thus the light representing a color image is synthesized. The synthesized light is projected on a screen 1300 by the projector lens 1207 which is a projection optical system, and the image is enlarged to be displayed.

The liquid crystal device 100 described above is applied to the liquid crystal light valve 1210. The liquid crystal device 100 is arranged between the pair of polarization elements that are arranged in a crossed Nichol prism in the direction of incoming color light and in the direction of outgoing color light, with a spacing in between. The same is true for the other liquid crystal light valves 1220 and 1230.

According to such a projection type display apparatus 1000, the liquid crystal device 100, in which the uneven distribution of the ionic impurities in the liquid crystal layer 50 is decreased, is provided, the display irregularity due to electric conduction is decreased, and thus a high display grade and reliability are realized.

The invention is not limited to the embodiments described above. Modifications thereto are possible within a scope not contrary to the gist or the idea of the invention, read from the claims and the entire specification, and a liquid crystal device entailed by the modification and an electronic apparatus to which the liquid crystal device is applied is also included in a technological scope of the invention. Various modification examples are considered in addition to the embodiments described above. The modification examples are described below.

### Modification Example 1

According to the first embodiment, the example is shown in which the protrusion portion 17 is integrally formed on the inter-layer insulating film 14, but the invention is not limited to this configuration, and the protrusion portion 17 may be formed on the inter-layer insulating film 14 between the pixel electrodes 15 using other member. For example, the protrusion portion 17 can be formed using Al₂O₃ (aluminium oxide) film and SiN (silicon nitride) film.

### Modification Example 2

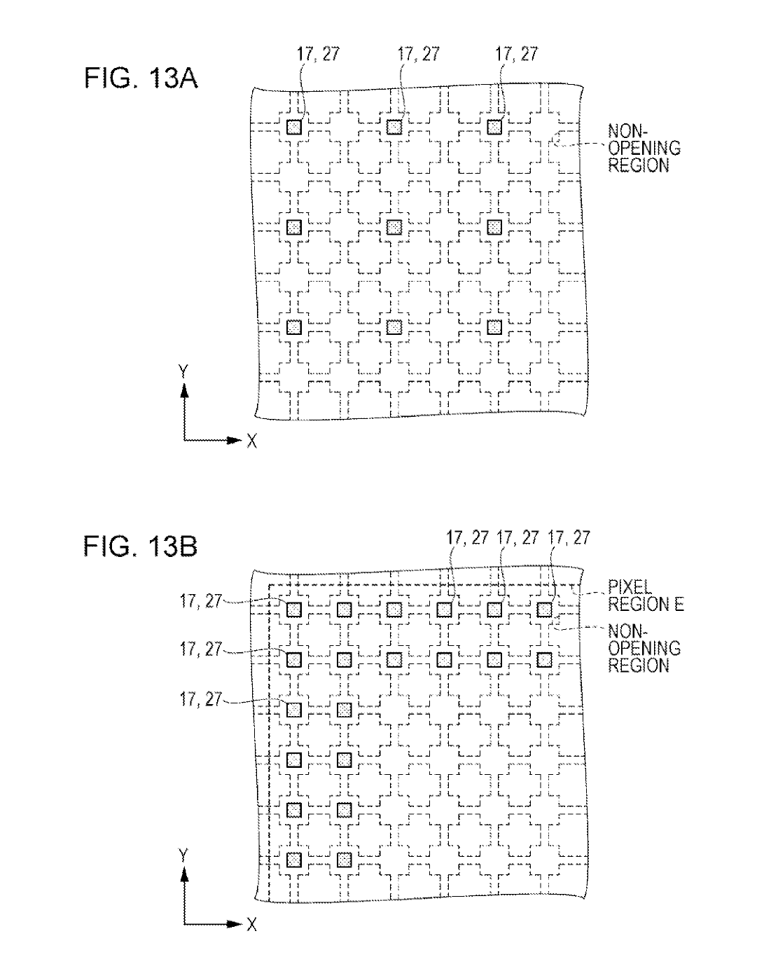

The protrusion portion 17(27) is not limited to being formed corresponding to all the intersection portions of the non-opening region in the pixel region E. FIGS. 13A and 13B are schematic plan views, each illustrating an arrangement of the protrusion portion according to the modification example.

For example, as illustrated in FIG. 13A, the protrusion portion 17(27) can be arranged corresponding to every other intersection portion in the X direction and in the Y direction of the non-opening region.

Also, for example, as illustrated in FIG. 13B, the protrusion portion 17(27) can be arranged corresponding to the intersection portion of the non-opening region of the pixel region E, which is close to the outside. In other words, the protrusion portion 17(27) may not provided on the intersection portion of the non-opening region of the pixel region E, which is close to the center. According to this configuration, an occurrence of the orientation irregularity in the liquid crystal molecule throughout the entire pixel region E can be decreased that results from the protrusion portion 17(27), compared to a case where the protrusion portion 17(27) is provided corresponding to all the intersection portions of the non-opening regions.

Besides, the protrusion portion 17(27) is not limited to one substrate of the pair of substrates, and a configuration may be possible in which the protrusion portion 17 is provided on the element substrate 10 and additionally the protrusion portion 27 is provided on the opposite substrate 20. According to this configuration, in each of the element substrate 10 and the opposite substrate 20, the display irregularity resulting from the uneven distribution of the ionic impurities can be decreased by causing the protrusion portion 17(27) to impede the flow of the liquid crystal molecule on the surface of the inorganic orientation film facing the liquid crystal layer 50.

### Modification Example 3

The liquid crystal device 100 to which the invention can be applied is not limited to the transmission type. For example, the invention can be applied also to a reflection type liquid crystal device in which the pixel electrode 15 is formed using a conductive film of light-reflection. Furthermore, in a case of the reflection type liquid crystal device, the base substrate 10s of the element substrate 10 is not limited to a base substrate of transmittance, but a semiconductor wafer can be used, such as silicon having a light-blocking property.

### Modification Example 4

The electronic apparatus to which the liquid crystal device 100 can be applied is not limited to the projection type display apparatus 1000 according to the third embodiment. For example, the liquid crystal device 100 can be suitably used as a projection type HUD (a head up display) and a direct view type HMD (a head mount display), or a display unit of an information terminal device, such as an electronic book, a personal computer, a digital still camera, a liquid crystal television, a view finder type or monitor direct view type video recorder, a car navigation system, an electronic organizer, and POS.

The entire disclosure of Japanese Patent Application No. 2012-107358, filed May 9, 2012 is expressly incorporated by reference herein.

What is claimed is:

1. A liquid crystal device comprising:
a first substrate;
a second substrate;
a liquid crystal layer that is interposed between the first substrate and the second substrate;
a protrusion portion that is provided on the first substrate, and that protrudes toward the liquid crystal layer; and
a plurality of pixel electrodes that are arranged in the vicinity of the protrusion portion,
wherein a space between an end of one of the plurality of pixel electrodes and an end of the protrusion portion is greater than a height of the protrusion portion.

2. A liquid crystal device comprising:
a first substrate;
a second substrate;
a liquid crystal layer that is interposed between the first substrate and the second substrate,
a plurality of pixel electrodes that are provided on the first substrate;
a common electrode that is provided on the second substrate, and is arranged opposite to the plurality of pixel electrodes; and
a protrusion portion that is provided at an opening portion of the common electrode, and that protrudes toward the liquid crystal layer,
wherein a space between an end of the opening portion of the common electrode and an end of the protrusion portion is greater than a height of the protrusion portion.

3. The liquid crystal device according to claim 1,
wherein the height of the protrusion portion is higher than a height of the pixel electrode or the common electrode, the height of the protrusion portion is 1 μm or less.

4. The liquid crystal device according to claim 1, further comprising:
a first interlayer insulating film that is provided between the first substrate and the plurality of pixel electrodes,
wherein the protrusion portion is formed on the first interlayer insulating film.

5. The liquid crystal device according to claim 2, further comprising:
a second interlayer insulating film that is provided between the second substrate and the common electrode,
wherein the protrusion portion is formed on the second interlayer insulating film.

6. The liquid crystal device according to claim 4,
wherein the first interlayer insulating film includes a first insulating film and a second insulating film, a material of the first insulating film is different from a material of the second insulating film, and
wherein among the first insulating film and the second insulating film, the insulating film positioned on the side of the liquid crystal layer has higher moisture absorption performance than the other insulating film.

7. The liquid crystal device according to claim 1,
wherein the plurality of pixel electrodes are arranged along a first direction and a second direction that intersects the first direction, in the first substrate, and
the protrusion portion includes,
a part that extends in the first direction, and
a part that extends in the second direction.

8. The liquid crystal device according to claim 1, further comprising:
an inorganic orientation film that is formed on the first substrate and the second substrate,
wherein the inorganic orientation film faces the liquid crystal layer the inorganic orientation film is formed by oblique deposition.

9. The liquid crystal device according to claim 8,
wherein the protrusion portion is arranged in such a manner that at least one side portion of the protrusion portion intersects a deposition direction of the oblique deposition.

10. The liquid crystal device according to claim 1,
wherein the space between the protrusion portion and the end of the one of the plurality of pixel electrodes and the protrusion portion, or the space between the end of the opening portion of the common electrode and the end of the protrusion portion is within a light blocking region when viewed from above.

11. An electronic apparatus comprising:
the liquid crystal device according to claim 1.

12. An electronic apparatus comprising:
the liquid crystal device according to claim 2.

13. An electronic apparatus comprising:
the liquid crystal device according to claim 3.

14. An electronic apparatus comprising:
the liquid crystal device according to claim 4.

15. An electronic apparatus comprising:
the liquid crystal device according to claim 5.

16. An electronic apparatus comprising:
the liquid crystal device according to claim 6.

17. An electronic apparatus comprising:
the liquid crystal device according to claim 7.

18. An electronic apparatus comprising:
the liquid crystal device according to claim 8.

19. An electronic apparatus comprising:
the liquid crystal device according to claim 9.

20. An electronic apparatus comprising:
the liquid crystal device according to claim 10.
